(19) United States
(12) Patent Application Publication
(10) Pub. No.: US 2015/0233553 A1
(43) Pub. Date: Aug. 20, 2015

(54) POSITIONING STRUCTURE FOR LAMP SHADE

(71) Applicant: SU-FANG HO, NEW TAIPEI CITY (TW)

(72) Inventor: SU-FANG HO, NEW TAIPEI CITY (TW)

(21) Appl. No.: 14/180,498

(22) Filed: Feb. 14, 2014

(51) Int. Cl. F21V 17/12; F21V 19/00; F21V 1/04

(52) U.S. Cl. CPC F21V 17/12; F21V 1/04; F21V 19/0015

(57) ABSTRACT

A positioning structure for lamp shade comprises a bracket; a main lamp holder having a lighting bulb mounted thereon; and a lamp shade covering the main lamp holder; wherein the bracket is a hollow tube having a thread section an upper end; a screw nut is provided for screwing the thread section; an LED bulb is arranged at the upper end of the bracket; at least a wire passes through the hollow tube of the bracket, and has an end connected to the power and the other end electrically connected to the main lamp holder and the LED bulb. Further, the positioning portion has a notch in a C-shaped. Whereby the notch of the positioning portion is combined with the thread section from a side of the bracket, and the screw nut is upward rotated for fixing the lamp shade on the bracket for easily removed.

### BACKGROUND OF THE INVENTION

1. Field of the Invention

The invention relates to a positioning structure for lamp shade, especially an LED bulb arranged on the top of the lamp shade, and the lamp shade is combined with the thread section from a side of the bracket.

2. Description of the Related Art

A conventional lamp 10 as shown in FIG. 1 comprises a base 11, a bracket 12, a main lamp holder 13, and the lamp shade 14. The main lamp holder 13 has one or a plurality of lighting bulbs 131 mounted thereon, and the lamp shade 14 has a ring positioning portion 141 at a top end thereof for combining with an upper end of the bracket 12 and being fixed by a screw nut 15; such that the lamp shade 14 is fixed on the bracket 12 to cover the main lamp shade 13.

The conventional lamp is not only used for lighting but placed at each corner of the bedroom in recent years, especially in the general hotel room as the floor-type or desktop lamp, so the lamps become main furniture combining the lighting and decoration. This type of lamps has luminous adjustment switch for adjusting the brightness.

However, there are little changes in the appearance of the conventional lamp, and the lighting bulb is lack of diversity.

Due to the mature LED light technology in recent years, the colors and varied shapes of the LED lights are very popular, and they are used in the bedroom home for providing the soft interior light, and diversity modeling decoration. Therefore, the inventor develops and creates a combination of traditional lamps with LED lights to become an integrated lighting which is easily removable.

### SUMMARY OF THE INVENTION

It is an object of the present invention to provide a positioning structure for lamp shade which combines the conventional lamp shade with the LED light to enhance the effectiveness of the use of the lamp.

It is another object of the present invention to provide an innovative positioning structure for lamp shade which is easily removable.

In order to achieve the above objects, the positioning structure for lamp shade comprises a bracket being a hollow tube with a thread section an upper end, and the bracket having a positioning member mounted at the upper end of the thread section; a main lamp holder arranged at a middle section of the bracket, and having a plurality of lighting bulbs thereon; a lamp shade having a frame body and a ring cover body, a center of the frame body having a positioning portion mounted on the bracket, and the positioning portion having a notch in a C-shaped, wherein a diameter of an inner edge of the positioning portion and a width of the notch are slightly greater than an outer diameter of the thread section; a screw nut having internal thread for screwing the thread section; an LED bulb arranged at the upper end of the bracket; and at least a wire passing through the hollow tube of the bracket, and having an end connected to the power and the other end electrically connected to the main lamp holder and the LED bulb.

The present invention further comprises a modeling lamp device mounted at a lower end of the bracket, the modeling lamp device having a modeling lamp holder and a lighting bulb arranged therein, and the wire connected to the modeling lamp holder for increasing the modeling. Further, the wire is connected to a transformer and a multi-stage switch for turning on/off and switching between the main lamp holder and LED bulb.

Based on the features disclosed, the present invention combines the traditional lamp with the LED light. The main lamp holder 30 and the lighting bulb 31 are arranged at middle portion of the bracket 20, the LED bulb 61 is arranged at the upper end of the Bracket 20, and the modeling lamp device 80 with the modeling lamp holder 81, and lighting bulb 82 is arranged at the lower end of the bracket 20. The wire 70 passes through the hollow tube 23 to connect to each lamp holder and bulb. The present invention further provides the positioning portion 43 with the notch 44 to set with the thread section from the side of the and provides the screw nut to be rotated upward to fix the lamp shade to the bracket without touching the LED bulb and any other components of the wire to enhance the service life.

### BRIEF DESCRIPTION OF THE DRAWINGS

FIG. 1 is a schematic view of conventional lamp;

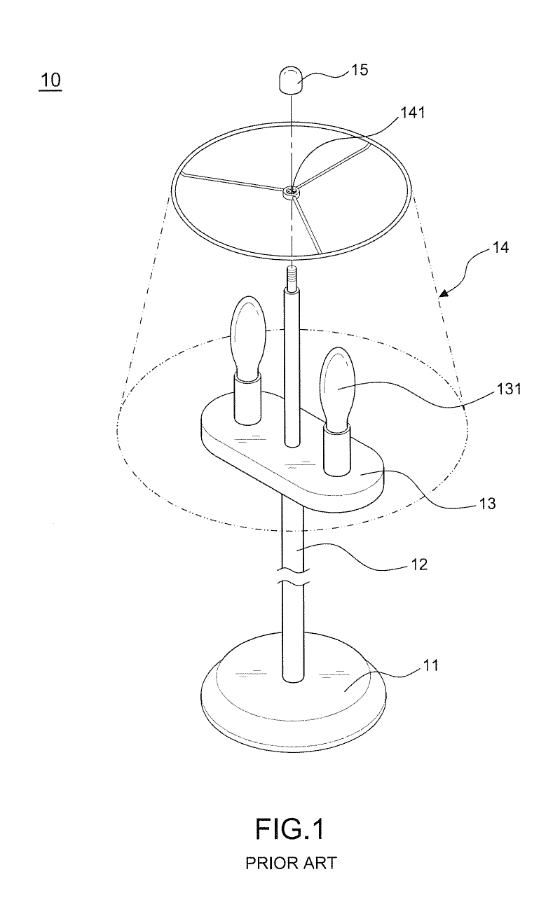

FIG. 2 is an exploded schematic view of the preferred embodiment in accordance with the present invention, showing a bracket with a main lamp holder and an LED bulb;

FIG. 3 is an assembly schematic view of the preferred embodiment in accordance with the present invention, showing the bracket with the main lamp holder and LED bulb;

FIG. 4 an assembly schematic view of the preferred embodiment in accordance with the present invention;

FIG. 5A is a perspective view of the preferred embodiment in accordance with the present invention, showing the lamp shade combining with the bracket;

FIG. 5B is a sectional view of the preferred embodiment in accordance with the present invention, showing the lamp shade combining with the bracket;

FIG. 6A is a perspective view of the preferred embodiment in accordance with the present invention, showing the screw nut fixing to the lamp shade;

FIG. 6B is a sectional view of the preferred embodiment in accordance with the present invention, showing the screw nut fixing to the lamp shade;

FIG. 7 is a perspective view of the preferred embodiment in accordance with the present invention using the upright bracket;

FIG. 8 is a perspective view of the preferred embodiment in accordance with the present invention using the curved bracket; and

FIG. 9 is a perspective view of the preferred embodiment in accordance with the present invention using both upright and curved brackets.

### DETAILED DESCRIPTION OF THE PREFERRED EMBODIMENT

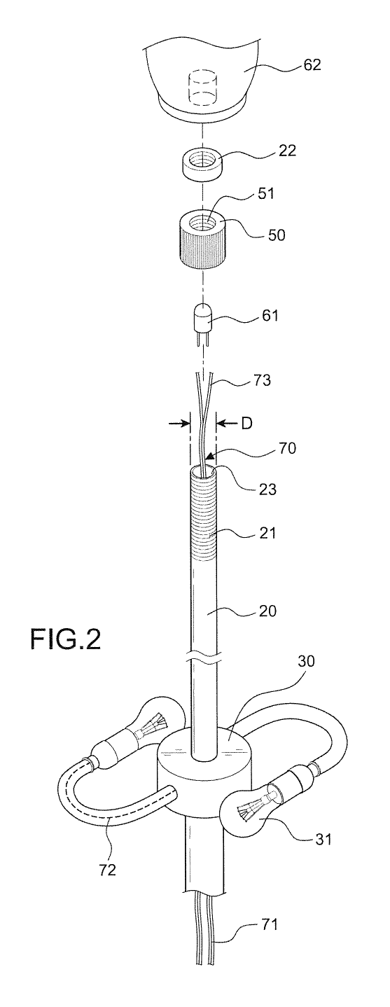

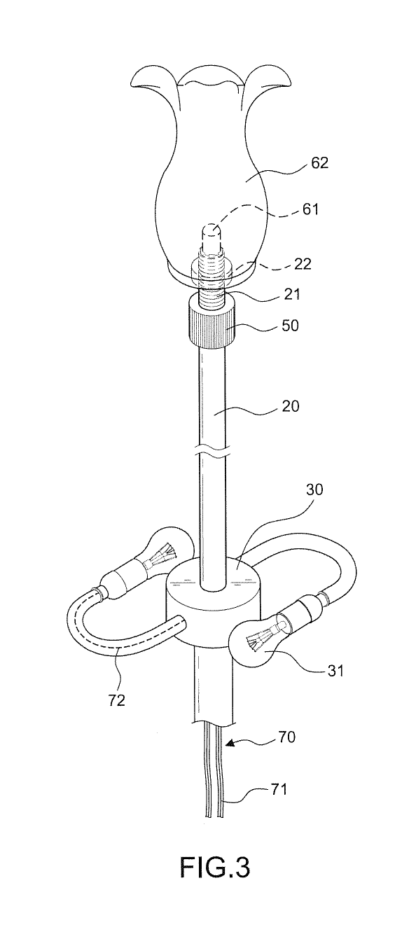

Referring to FIGS. 2 through 4, the preferred embodiment of a positioning structure for lamp shade in accordance with the present invention comprises the following components as discussed in detail below.

A bracket 20 is a hollow tube 23 with a thread section 21 at an upper end, and the thread section 21 has a positioning member 22 at an upper end thereof. In the embodiment, the positioning member 22 is a screw nut. A main lamp holder 30 arranged at a middle section of the bracket 20 having a lighting bulb 31 mounted thereon for lighting. There are two lighting bulbs installed in the preferred embodiment. A lamp shade 40 has a frame body 41 and a ring cover body 42, and a center of the frame body 41 has a positioning portion 43 with a notch 44 in a C-shape. A diameter d of an inner edge of the positioning portion 43 and a width W of the notch 44 are slightly greater than an outer diameter D of the thread section 21. An LED bulb 61 is arranged at the upper end of the bracket 20 and has a lamp shell 62 covering the LED bulb 61. At least a wire 70 passes through the hollow tube 23 of the bracket 20, and has an end 71 connected to the power and the other end 72, 73 electrically connected to the main lamp holder 30 and the LED bulb 61. The wire 70 is connected to a transformer and a multi-stage switch (not shown) for turning on/off and switching between the main lamp holder 30 and LED bulb 61.

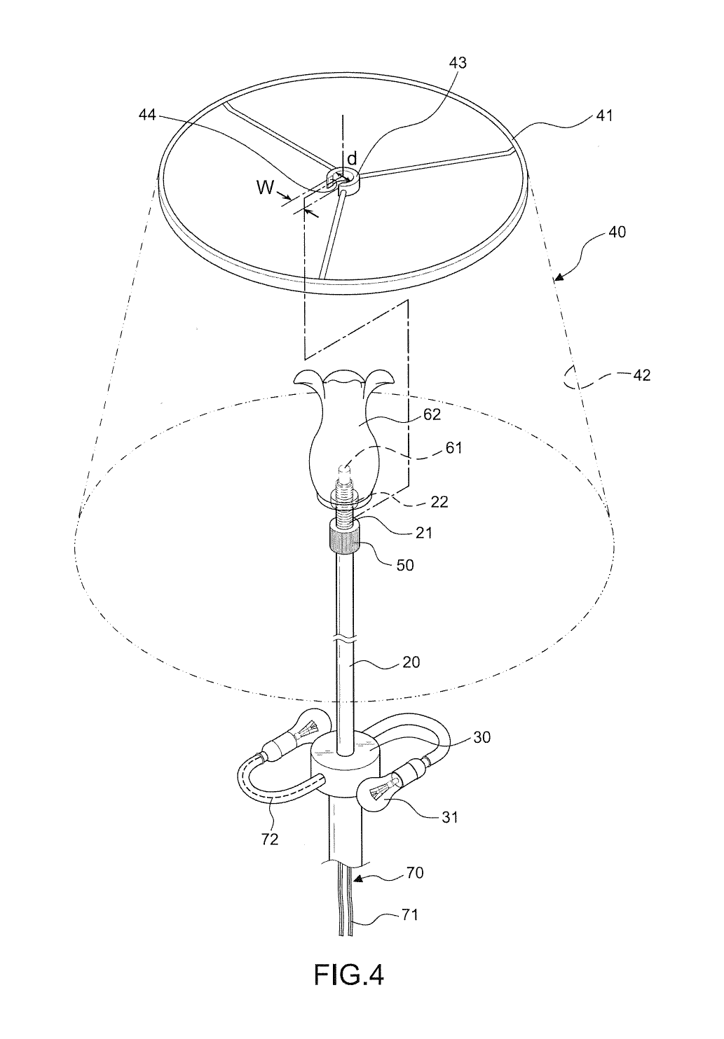

With the referenced to FIG. 4, the notch 44 of the positioning portion 43 is combined with the thread section 21 from a side of the bracket 20. The positioning portion 43 may be set to the thread section 21 easily for the diameter d of an inner edge of the positioning portion 43 and the width W of the notch 44 are slightly greater than the outer diameter D of the thread section 21.

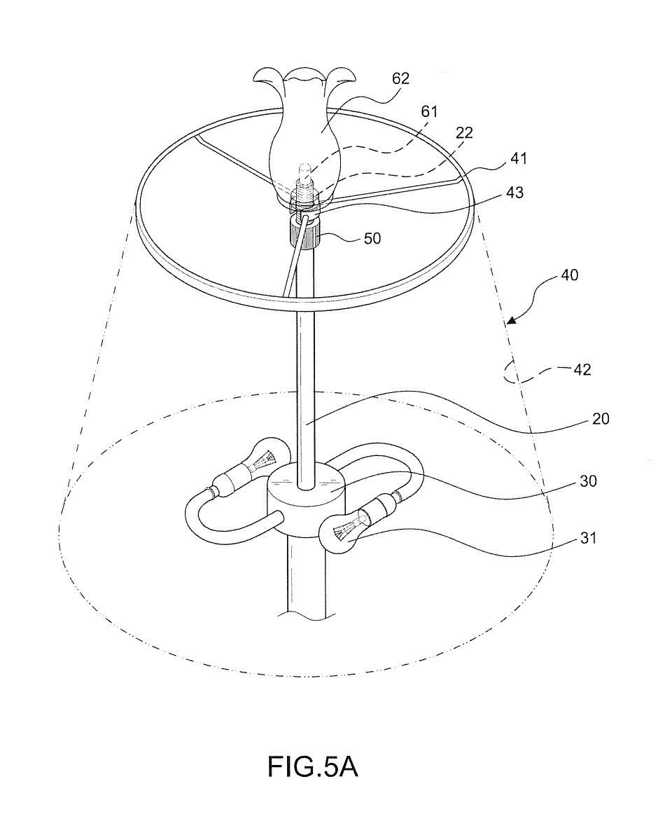

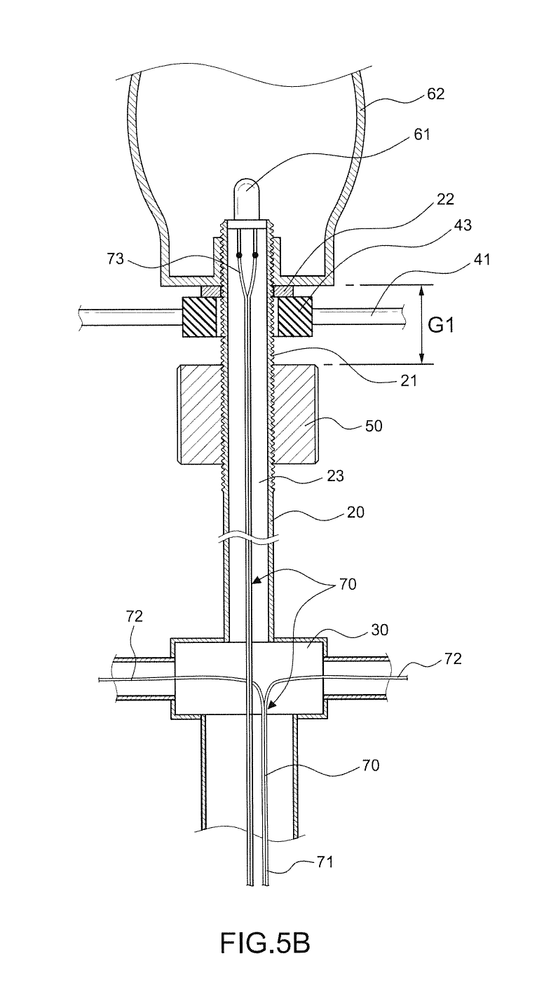

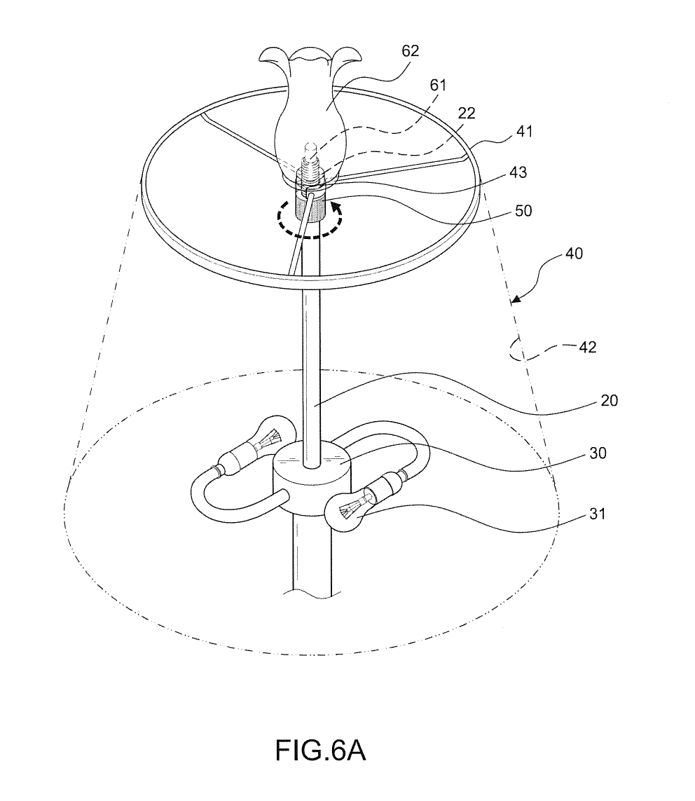

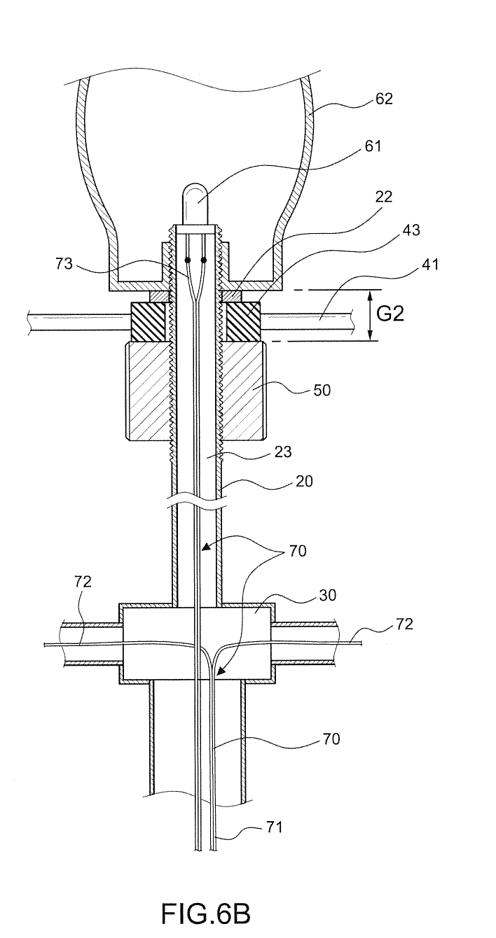

With the referenced to FIGS. 5A and 5B, there is a gap G1 between a top end of the screw nut 50 and a lower end of the lamp shell 62, and the gap G1 is greater than a height of the positioning portion 43 so the lamp shade 40 cannot be fixed to the bracket 20 after combining the positioning portion 43 with the thread section 21. Therefore, the screw nut 50 is upward rotated until the screw nut 50 touches the bottom of the positioning portion 43, and the positioning portion 43 touches the bottom of the positioning member 22 as shown in FIGS. 6A and 6B. At this time, the gap G2 between the top end of the screw nut 50 and the lower end of the lamp shell 62 is equal to the height of the positioning portion 43 and positioning member 22 for stably fixing the lamp shade 40 to the bracket 20. Through the conversed action, the lamp shade 40 is removed easily.

In the embodiment, while installing or removing the lamp shade 40, there is no need to touch the LED bulb 61, lamp shell 62, and the wire 70 so that the lamp shade 40 and the other components of the lamp can be separately shipped to reduce packaging volume. Due to dust or other factors, the lamp shade may be removed for cleaning, so the feature without touching other member for removing the lamp shade may enhance the life of the present invention. Moreover, different shapes of the lamp shade allows buyers to choose freely, and then to easily assemble onto the lamp bracket in order to increase the selectivity of the lamp shade 40.

The present invention further includes a modeling lamp device 80 mounted at a lower end of the bracket 20, the modeling lamp device 80 having a modeling lamp holder 81 and a lighting bulb 82 arranged therein,

What is claimed is:

1. A positioning structure for lamp shade, comprising:
a bracket;
a main lamp holder arranged at a middle section of the bracket, and having a lighting bulb mounted thereon;
a lamp shade having a frame body and a ring cover body, a center of the frame body having a positioning portion mounted on the bracket, and the cover body provided for covering the main lamp holder;
wherein the bracket is a hollow tube having a thread section an upper end;
a screw nut has internal thread for screwing the thread section;
an LED bulb is arranged at the upper end of the bracket;
at least a wire passes through the hollow tube of the bracket, and has an end connected to the power and the other end electrically connected to the main lamp holder and the LED bulb; and
the positioning portion has a notch in a C-shaped, and a diameter of an inner edge of the positioning portion and a width of the notch are slightly greater than an outer diameter of the thread section;
whereby the LED bulb is mounted on the top of the lamp shade for combining with the main lamp holder to form an integrated lighting device, and the notch of the positioning portion is combined with the thread section from a side of the bracket, and the screw nut is upward rotated for fixing the lamp shade on the bracket; through the conversed action, the lamp shade is removed easily.

2. The positioning structure for lamp shade as claimed in claim 1, further comprising a positioning member mounted at the upper end of the thread section and at a bottom of the LED bulb.

3. The positioning structure for lamp shade as claimed in claim 2, further comprising a modeling lamp device mounted at a lower end of the bracket, the modeling lamp device having a modeling lamp holder and a lighting bulb arranged therein, and the wire connected to the modeling lamp holder.

4. The positioning structure for lamp shade as claimed in claim 3, wherein the wire is connected to a transformer and a multi-stage switch.

5. The positioning structure for lamp shade as claimed in claim 4, wherein the main lamp holder has a plurality of lighting bulbs.

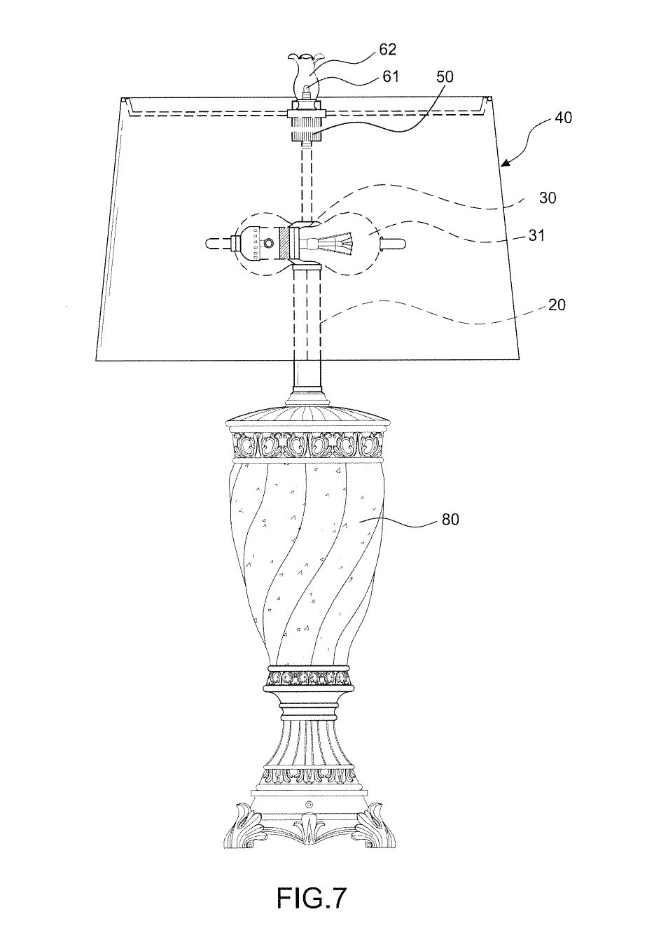

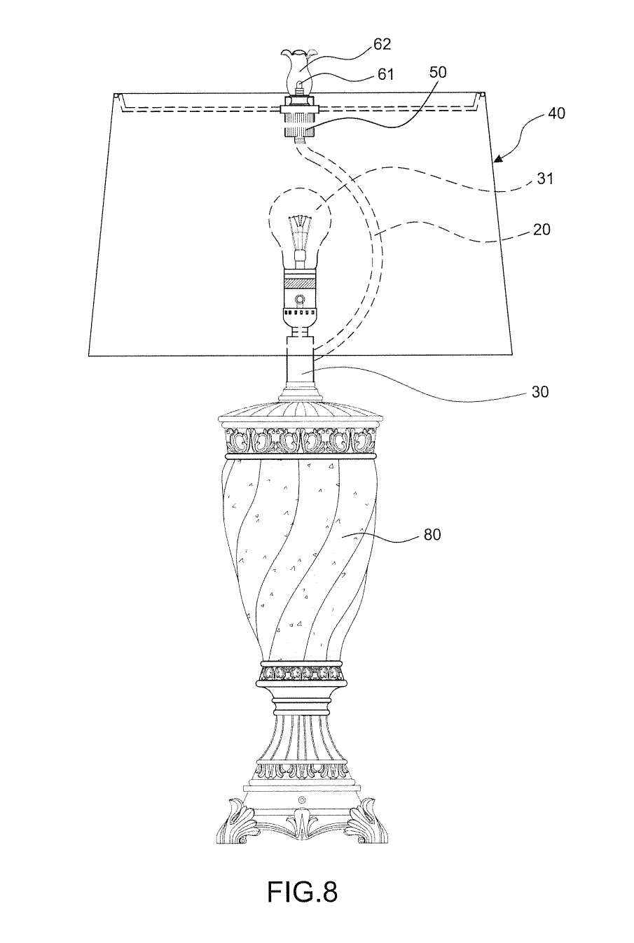

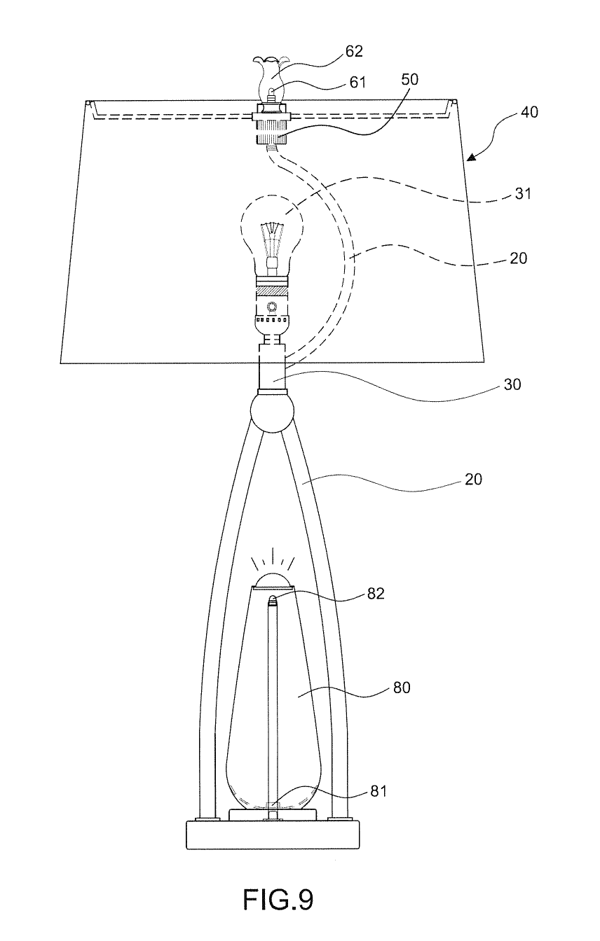

6. The positioning structure for lamp shade as claimed in claim 1, wherein the LED bulb has a lamp shell covering the LED bulb. and the wire 70 connected to the modeling lamp holder 81. The upright bracket 20 is shown in FIG. 7, and the curved bracket 20 is shown in FIG. 8. With the reference to FIG. 9, the upper portion of the bracket 20 is curved and the lower portion is in a discrete type.
Based on the features disclosed, the present invention combines the traditional lamp with the LED light. The main lamp holder 30 and the lighting bulb 31 are arranged at middle portion of the bracket 20, the LED bulb 61 is arranged at the upper end of the Bracket 20, and the modeling lamp device 80 with the modeling lamp holder 81, and lighting bulb 82 is arranged at the lower end of the bracket 20. The wire 70 passes through the hollow tube 23 to connect to each lamp holder and bulb for switching different illumination. The present invention further provides the positioning portion 43 with the notch 44 to be easily removed for cleaning and changing the formative of the lamp shade 40.
Although particular embodiments of the invention have been described in detail for purposes of illustration, various modifications and enhancements may be made without departing from the spirit and scope of the invention. Accordingly, the invention is not to be limited except as by the appended claims.
